(19) United States
(12) Patent Application Publication
(10) Pub. No.: US 2009/0059858 A1
(43) Pub. Date: Mar. 5, 2009

(54) System and Method for requesting bandwidth allocation and allocating bandwidth in communication system

(75) Inventors: Ok-Seon Lee, Suwon-si (KR); Jong-Hyung Kwun, Seongnam-si (KR); Jung-Hoon Cheon, Suwon-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/231,019

(22) Filed: Aug. 28, 2008

(30) Foreign Application Priority Data
Aug. 31, 2007 (KR) 2007-0088569
Nov. 30, 2007 (KR) 2007-0123788

(51) Int. Cl. H04W 4/00

(52) U.S. Cl. 370/329

(57) ABSTRACT

Disclosed is a method of requesting bandwidth allocation by an MS having at least two CIDs in a communication system, the method including the steps of detecting at least one CID needing the bandwidth allocation; when a plurality of CIDs are detected, generating a grant management subheader including a region for recording the total number of the CIDs needing bandwidth allocation and a region for recording bandwidth information of a generic MAC header CID, and a grant management subheader including, for each of the CIDs needing bandwidth allocation, other than the generic MAC header CID, a region for recording the order of a corresponding CID given in a MS CID list and a region for recording bandwidth information of the corresponding CID; and transmitting the generic MAC header with the grant management subheaders concatenated thereto to a BS.

### CROSS-REFERENCE TO RELATED APPLICATION(S) AND CLAIM OF PRIORITY

The present application claims priority to applications entitled “System and Method for Requesting Bandwidth Allocation and Allocating Bandwidth in Communication System” filed in the Korean Industrial Property Office on Aug. 31 and Nov. 30, 2007, and assigned Serial Nos. 2007-0088569 and 2007-0123788 respectively, the contents of which are hereby incorporated by reference.

### TECHNICAL FIELD OF THE INVENTION

The present invention relates to a communication system and, more particularly, to a system and method for requesting uplink (hereinafter referred to as “UL”) bandwidth allocation by a mobile station (hereinafter referred to as “MS”) and allocating a bandwidth to the MS by a base station (hereinafter referred to as “BS”) in response to the bandwidth allocation request.

### BACKGROUND OF THE INVENTION

Since resources available in a communication system are limited, research is being actively conducted to efficiently use the resources. In order to efficiently-use limited resources, it is essential to prevent the resources from being unnecessarily wasted, and to quickly recover already allocated resources and reallocate them for other services.

In addition, a BS must be able to quickly allocate a bandwidth in response to a UL bandwidth allocation request from an MS. While the UL bandwidth allocation request is made according to connection identifiers (hereinafter referred to as “CID”) of an MS, a BS allocates a bandwidth on an MS-by-MS basis. That is, an MS requests a required bandwidth for each CID and a BS collects information about requested bandwidths for respective CIDs, and allocates the bandwidths to respective MSs. Here, a way for an MS to request UL bandwidth allocation may be divided into two schemes, a polling scheme and a piggyback scheme.

First, the polling scheme refers to a scheme for requesting bandwidth allocation by transmitting a 6-byte bandwidth request header in which information on a UL bandwidth needed by a corresponding CID is recorded according to the CIDs of an MS at predetermined periodic intervals. Here, as an example, the information on a bandwidth may be information on the amount of a bandwidth.

FIG. 1 illustrates a structure of a UL bandwidth request header.

Referring to FIG. 1, the UL bandwidth request header includes a header type (hereinafter referred to as “HT”) field 101, an encoding (hereinafter referred to as “EC”) field 103, a type field 105, a bandwidth request (hereinafter referred to as “BR”) field 107, 109, a CID field 111, 113, and a header check sequence (hereinafter referred to as “HCS”) field 115.

Next, before explaining the piggyback scheme, a structure of a generic media access control (hereinafter referred to as “MAC”) header will be discussed with reference to FIG. 2.

FIG. 2 illustrates a structure of a generic MAC header.

Referring to FIG. 2, the generic MAC header includes an HT field 201, an EC field 203, a type field 205, 206, an extended subheader field 207 (hereinafter referred to as “ESF”) indicating whether or not an extended subheader exists, a CRC (Cyclic Redundancy Check) indicator (hereinafter referred to as “CI”) field 209 indicating a CRC error, an encryption key sequence (hereinafter referred to as “EKS”) field 211 including information on a key used for payload encryption, a reserved (hereinafter referred to as “Rsv”) field 213, a length (hereinafter referred to as “LEN”) field 215, 217, a CID field 219, 221, and an HCS field 223.

The piggyback scheme refers to a scheme for requesting bandwidth allocation by setting the least significant bit (hereinafter referred to as “LSB”) 206 of the type field 205, 206 of the generic MAC header in such a manner that a grant management subheader is attached to the generic MAC header (i.e., setting the LSB 206 of the type field to “1” and then transmitting the generic MAC header to which a 2-byte grant management subheader containing information on a UL bandwidth needed by a corresponding CID is postfixed). Here, the LSB 206 of the generic MAC header type field 205, 206 is a bit indicating whether or not to set a grant management subheader, and information on the number of bytes of a bandwidth needed by a corresponding CID in excess of an already allocated bandwidth is recorded in the grant management subheader. The contents of the grant management subheader vary according to the service class types of the corresponding CIDs, and the format of the grant management subheader may be represented as given below in Table 1.

TABLE 1

| | Size | |
|---|---|---|
| Syntax | (bits) | Notes |
| Grant management subheader( ) { | | |
| if (scheduled service type = = USG) { | | |
| SI | 1 | |
| PM | 1 | |
| FLI | 1 | |
| FL | 4 | |
| Reserved | 9 | Shall be set to zero |
| }elseif (scheduled service | | |
| type = = extended rtPS) { | | |
| Extended Piggyback Request | 11 | |
| FLI | 1 | |
| FL | 4 | |
| }else { | | |
| Piggyback Request | 16 | |
| } | | |

Although the grant management subheader format shown in Table 1 relates to an unsolicited guaranteed service (hereinafter referred to as “UGS”) and an extended real-time polling service (hereinafter referred to as “rtPS”) by way of example. The contents of the grant management subheader vary according to service types. Such scheduled service types includes a non real-time polling service (hereinafter referred to as “nrtPS”) and a best effort service (hereinafter referred to as “BE”), as well as the UGS and the rtPS.

A description of each field of the grant management subheader is given below in Table 2.

TABLE 2

| | Length | |
|---|---|---|
| Name | (bits) | Description |
| SI | 1 | Slip indicator |
| | | 0 = No Action |
| | | 1 = Used by the MS to indicate a slip of uplink grants relative to the |
| | | uplink queue depth |
| PM | 1 | Poll-Me |
| | | 0 = No Action |
| | | 1 = used by the MS to request a bandwidth poll |
| FLI | 1 | Frame Latency indication |
| | | 0 = Frame latency field disabled for this grant |
| | | 1 = Frame latency field enabled for this grant |
| FL | 4 | Frame Latency |
| | | The number of frames previous to the current one in which the |
| | | transmitted data was available. When the latency is greater than 15, |
| | | the FL field shall be set to 15. |
| Extended | 11 | Extended Piggyback Request |
| PBR | | The number of bytes of uplink bandwidth requested by the MS. |
| | | The bandwidth request is for the CID. The request shall not include |
| | | any PHY overhead. The request shall be incremental. In case of |
| | | the Extended rtPS, if the MSB is 1, the BS changes its polling size |
| | | into the size specified in the LSBs of this field. |
| Piggyback | 16 | Piggyback Request |
| Request | | The number of bytes of uplink bandwidth requested by the MS. |

An MS may request bandwidth allocation for a plurality of CIDs, as well as bandwidth allocation for one CID. However, the above-mentioned piggyback scheme may be used only when bandwidth allocation for one CID, in particular, a CID included in the generic MAC header of an MS (hereinafter referred to as “generic MAC header CID”), is requested.

FIG. 3 illustrates an operation of requesting bandwidth allocation for a plurality of CIDs including a generic MAC header CID by an MS in a typical communication system.

Referring to FIG. 3, MS #1 310 transmits a message as illustrated in the drawing to a BS in order to request bandwidth allocation for a plurality of CIDs. The plurality of CIDs are those included in a CID list 300 in which all CIDs possessed by the MS #1 310 are arranged in a particular order, and include CID #205 (hereinafter referred to as “1^{st} CID”) 301, CID #302 (hereinafter referred to as “2^{nd} CID”) 303, and CID #4331 (hereinafter referred to as “3^{rd} CID) 305 by way of example. Here, the 1^{st} CID 301 is the generic MAC header CID, and thus the MS #1 310 uses a 2-byte grant management subheader 330 to request bandwidth allocation for the 1^{st} CID 301. Also, the MS #1 310 uses 6-byte bandwidth request headers 340, 350 to request bandwidth allocation for the 2^{nd} CID 303 and the 3^{rd} CID 305, respectively.

That is, the MS #1 310 transmits a message, in which the grant management subheader 330 containing information on a bandwidth 302 needed by the 1^{st} CID 301, the bandwidth request header 340 containing the 2^{nd} CID 303 and information on a bandwidth 304 needed by the 2^{nd} CID 303, and the bandwidth request header 350 containing the 3^{rd} CID 305 and information on a bandwidth 306 needed by the 3^{rd} CID 305 are concatenated with the generic MAC header 320, to the BS.

Upon receiving the message, the BS detects the 1^{st} CID 301 and the bandwidth 302 needed by the 1^{st} CID 301 through the generic MAC header 320 and the grant management subheader 330, detects the 2^{nd} CID 303 and the bandwidth 304 needed by the 2^{nd} CID 303 through the bandwidth request header 340, detects the 3^{rd} CID 305 and the bandwidth 306 needed by the 3^{rd} CID 305 through the bandwidth request header 350, and then allocates the detected bandwidths to the MS #1 310.

FIG. 4 illustrates an operation of requesting bandwidth allocation for a plurality of CIDs excluding a generic MAC header CID by an MS in a typical communication system.

Referring to FIG. 4, MS #1 410 transmits a message as illustrated in the drawing to a BS in order to request bandwidth allocation for a plurality of CIDs. The plurality of CIDs are those included in a CID list 400 of the MS #1 410, and include a 1^{st} CID 403, a 2^{nd} CID 405, and a 3^{rd} CID 407 by way of example. Also, the generic MAC header CID of the MS #1 410 is CID #105 401, and thus the MS #1 410 uses 6-byte bandwidth request headers 430, 440, 450 to request bandwidth allocation for the 1^{st} CID 403, the 2^{nd} CID 405, and the 3^{rd} CID 407, respectively.

That is, the MS #1 410 transmits a message, in which the bandwidth request header 430 containing the 1^{st} CID 403 and information on a bandwidth 402 needed by the 1^{st} CID 403, the bandwidth request header 440 containing the 2^{nd} CID 405 and information on a bandwidth 404 needed by the 2^{nd} CID 405, and the bandwidth request header 450 containing the 3^{rd} CID 407 and information on a bandwidth 406 needed by the 3^{rd} CID 407 are concatenated with the generic MAC header 420, to the BS.

Upon receiving the message, the BS detects the generic MAC header CID through the generic MAC header 420, detects the 1^{st} CID 403 and the bandwidth 402 needed by the 1^{st} CID 403 through the bandwidth request header 430, detects the 2^{nd} CID 405 and the bandwidth 404 needed by the 2^{nd} CID 405 through the bandwidth request header 440, detects the 3^{rd} CID 407 and the bandwidth 406 needed by the 3^{rd} CID 407 through the bandwidth request header 450, and then allocates the detected bandwidths to the MS #1 410.

As mentioned above, a way for an MS to request UL bandwidth allocation includes a polling scheme and a piggyback scheme.

However, the polling scheme has a problem in that latency occurs due to a fixed polling cycle when a bandwidth allocation request is generated in the middle of the polling cycle interval, and a UL resource allocated for a bandwidth request header is wasted when an MS does not transmit the bandwidth request header at a fixed point of polling.

Also, although the piggyback scheme has an advantage in that it has high utility because it can be used if only UL transmission data exists and its overhead is less than that of the polling scheme, it is available only when bandwidth allocation for a generic header CID is requested. Thus, in order to request bandwidth allocation for a CID other than the generic MAC header CID among all CIDs possessed by an MS, the MS must use a 6-byte bandwidth request header. Also, in requesting bandwidth allocation for a plurality of CIDS, a bandwidth request header is required for each CID, which increases overhead.

### SUMMARY OF THE INVENTION

To address the above-discussed deficiencies of the prior art, it is a primary object to provide a system and method, in which an MS requests UL bandwidth allocation for a CID other than a generic MAC header CID by using a piggyback scheme, and a BS allocates a bandwidth for the CID in response to the bandwidth allocation request.

Further, the present invention provides a system and method, in which an MS requests bandwidth allocation for a plurality of CIDs by using a piggyback scheme, and a BS allocates bandwidths for the CIDs in response to the bandwidth allocation request.

In accordance with an aspect of the present invention, there is provided a method of requesting bandwidth allocation by an MS (Mobile Station) having at least two CIDs (connection identifiers) in a communication system, the method including the steps of detecting at least one CID needing the bandwidth allocation; when the detected at least one CID is one in number, generating a grant management subheader including a region for recording the order of the CID, given in a list where the CIDs of the MS are arranged in a particular order, and a region for recording information on a bandwidth requested for the CID; and transmitting a generic MAC (media access control) header with the grant management subheader concatenated therewith to a BS (base station), wherein the CID is different from a CID included in the generic MAC header.

In accordance with another aspect of the present invention, there is provided a method of requesting bandwidth allocation by an MS (mobile station) having at least two CIDs (connection identifiers) in a communication system, the method including the steps of detecting at least one CID needing the bandwidth allocation; when the detected at least one CID is plural in number, generating a grant management subheader including a region for recording the total number of the CIDs needing the bandwidth allocation and a region for recording information on a bandwidth requested for a CID included in a generic MAC (media access control) header, and a grant management subheader including, for each CID other than the CID included in the generic MAC header among the CIDs needing the bandwidth allocation, a region for recording the order of a corresponding CID, given in a list where the CIDs of the MS are arranged in a particular order, and a region for recording information on a bandwidth requested for the corresponding CID; and transmitting the generic MAC header with the grant management subheaders concatenated therewith to a BS (Base Station).

In accordance with yet another aspect of the present invention, there is provided a method of requesting bandwidth allocation by an MS (mobile station) having at least two CIDs (connection identifiers) in a communication system, the method including the steps of detecting at least one CID needing the bandwidth allocation; and when the detected at least one CID is plural in number, transmitting a generic MAC (media access control) header, with which an extended subheader group length field, an extended subheader type field having a second value, and an extended subheader body field corresponding to the extended subheader type field are concatenated, to a BS (base station), wherein the extended subheader body field includes a grant management subheader including a region for recording the total number of the CIDs needing the bandwidth allocation and a region for recording information on a bandwidth requested for a CID included in the generic MAC header, and a grant management subheader including, for each CID other than the CID included in the generic MAC header among the CIDs needing the bandwidth allocation, a region for recording the order of a corresponding CID, given in a list where the CIDs of the MS are arranged in a particular order, and a region for recording information on a bandwidth requested for the corresponding CID.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view illustrating a structure of a bandwidth request header;

FIG. 2 is a view illustrating a structure of a generic MAC header;

FIG. 3 is a view illustrating an operation of requesting bandwidth allocation for a plurality of MS CIDs including a generic MAC header CID in a typical communication system;

FIG. 4 is a view illustrating an operation of requesting bandwidth allocation for a plurality of MS CIDs excluding a generic MAC header CID in a typical communication system;

FIG. 5 is a view illustrating a structure of a generic MAC header used in a communication system in accordance with an exemplary embodiment of the present invention;

FIG. 6 is a view illustrating a structure of a grant management subheader used in a communication system in accordance with an exemplary embodiment of the present invention;

FIG. 7 is a view illustrating an operation of requesting bandwidth allocation by performing single piggyback for a CID other than a generic MAC header CID in a communication system in accordance with a first exemplary embodiment of the present invention;

FIG. 8 is a view illustrating an operation of requesting bandwidth allocation by performing single piggyback for a CID other than a generic MAC header CID in a communication system in accordance with a second exemplary embodiment of the present invention;

FIG. 9 is a view illustrating an operation of requesting bandwidth allocation by performing multiple piggyback in a communication system in accordance with a third exemplary embodiment of the present invention;

FIG. 10 is a view illustrating an operation of requesting bandwidth allocation by performing multiple piggyback in a communication system in accordance with a fourth exemplary embodiment of the present invention;

FIG. 11 is a view illustrating an operation of requesting bandwidth allocation by performing multiple piggyback in a communication system in accordance with a fifth exemplary embodiment of the present invention;

FIG. 12 is a flowchart illustrating a procedure of requesting bandwidth allocation by an MS in a communication system in accordance with an exemplary embodiment of the present invention;

FIG. 13 is a view illustrating a procedure of allocating a bandwidth by a BS in correspondence with a bandwidth allocation request from an MS in a communication system in accordance with an exemplary embodiment of the present invention;

FIG. 14 is a view illustrating a structure of an extended subheader group;

FIG. 15 is a view illustrating an operation of requesting bandwidth allocation by performing single piggyback in a communication system in accordance with a sixth exemplary embodiment of the present invention;

FIG. 16 is a view illustrating an operation of requesting bandwidth allocation by performing multiple piggyback in a communication system in accordance with a seventh exemplary embodiment of the present invention; and

FIG. 17 is a view illustrating an operation of requesting bandwidth allocation by performing multiple piggyback in a communication system in accordance with an eighth exemplary embodiment of the present invention.

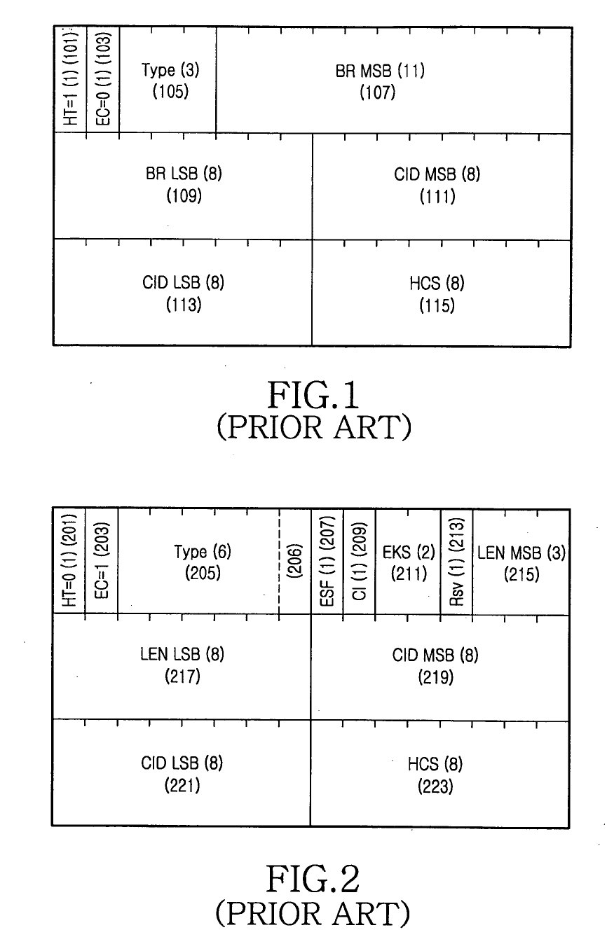

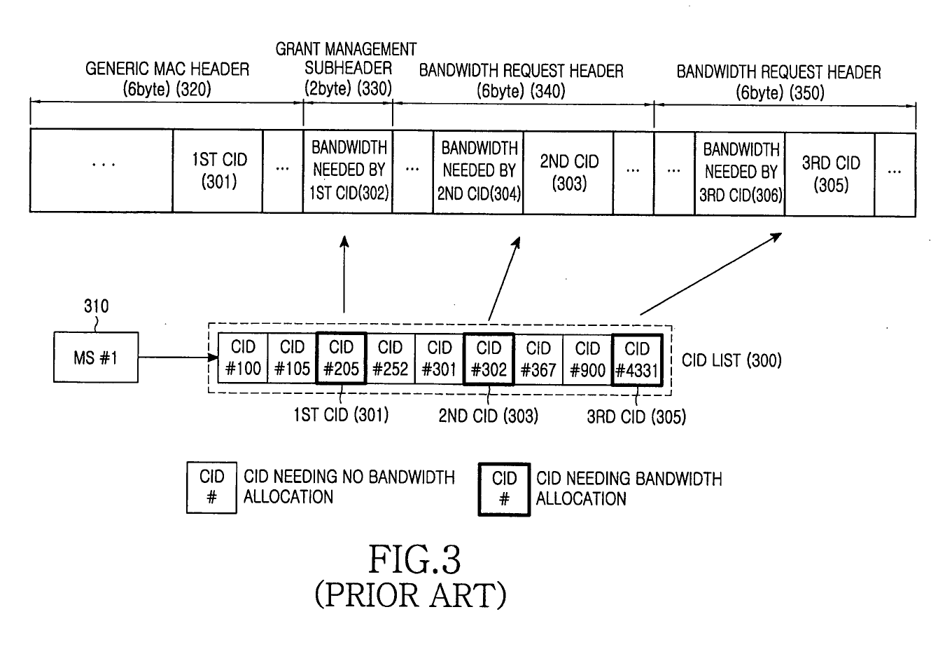

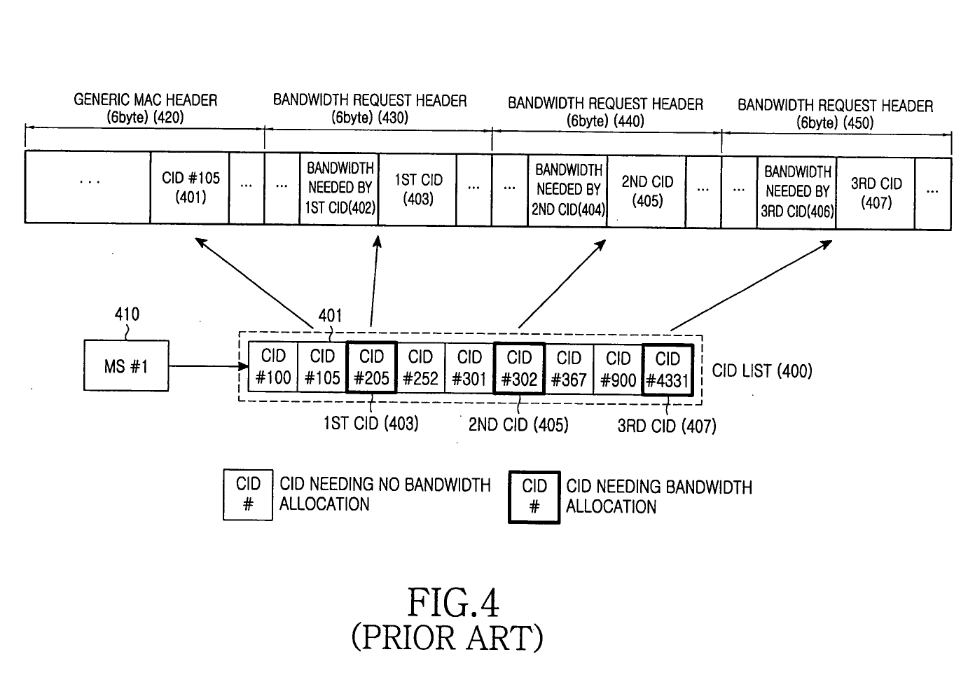

### DETAILED DESCRIPTION OF THE INVENTION

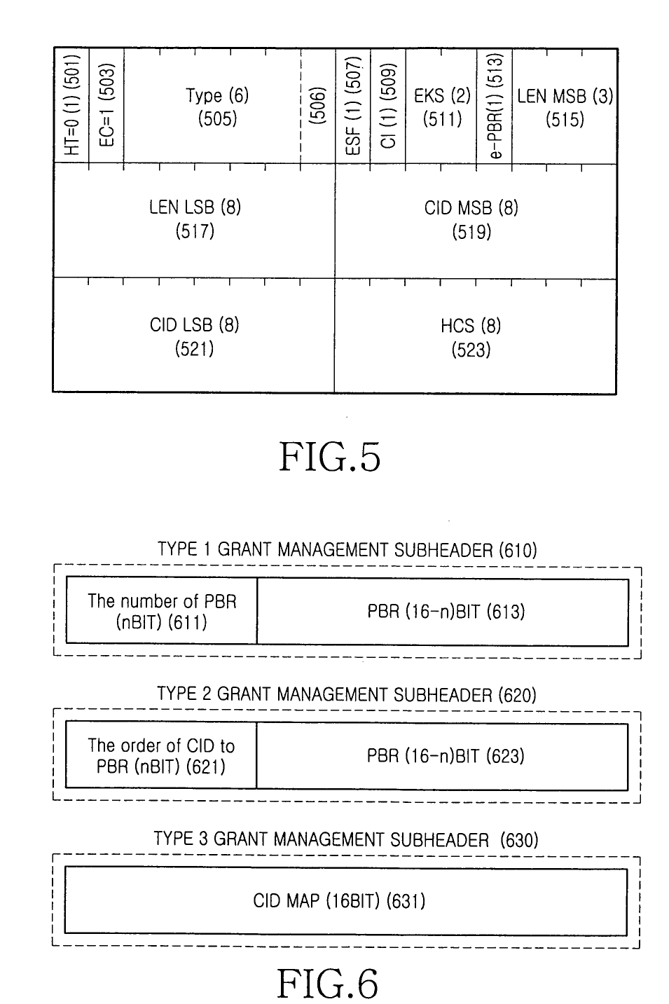

FIGS. 5 through 17, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system. Hereinafter, exemplary embodiments of the present invention will be described with reference to the accompanying drawings. It should be noted that the similar components are designated by similar reference numerals although they are illustrated in different drawings. Also, in the following description, a detailed description of known functions and configurations incorporated herein will be omitted when it may obscure the subject matter of the present invention. Further, it should be noted that only parts essential for understanding the operations according to the present invention will be described and a description of parts other than the essential parts will be omitted in order not to obscure the gist of the present invention.

The present invention proposes a system and method, in which an MS requests UL bandwidth allocation for a plurality of CIDs by using a piggyback scheme (i.e., by transmitting a generic MAC header with a grant management subheader), and a BS allocates bandwidths in response to the bandwidth allocation request from the MS. Here, the piggyback scheme refers to a scheme for requesting bandwidth allocation by setting the least significant bit (LSB) of the type field of a generic MAC header in such a manner that a grant management subheader is attached to the generic MAC header (i.e., setting the LSB of the type field to “1”, and then transmitting the generic MAC header to which a 2-byte grant management subheader containing information on a UL bandwidth needed by a corresponding CID (hereinafter referred to as “bandwidth information”) is postfixed). For the convenience of explanation, a scheme in which an MS requests bandwidth allocation by performing piggyback for one CID will be defined as a “single piggyback scheme”, and a scheme in which an MS requests bandwidth allocation by performing piggyback for each of a plurality of MS CIDs other than a generic MAC header CID will be defined as a “multiple piggyback scheme” in the following description.

FIG. 5 illustrates a structure of a generic MAC header used in a communication system according to an exemplary embodiment of the present invention.

Referring to FIG. 5, the generic MAC header includes an HT field 501, an EC field 503, a type field 505, 506, an ESF 507 indicating whether or not an extended subheader exists, a CI field 509 indicating a CRC error, an EKS field 511 containing information on a key used for payload encryption, an extended piggyback request (hereinafter referred to as “e-PBR”) field 513 newly proposed in the present invention, an LEN field 515, 517, a CID field 519, 521, and an HCS field 523.

Schemes for bandwidth allocation request, newly proposed in the present invention, in which an MS requests bandwidth allocation for a CID other than a generic MAC header CID among MS CIDs by using single piggyback and a scheme in which an MS requests bandwidth allocation for a plurality of CIDs other than a generic MAC header CID by using multiple piggyback are distinguished from each other by a combination of the type field LSB 506 and the e-PBR 513 bit of the generic MAC header.

FIG. 6 illustrates a structure of a grant management subheader used in a communication system according to an exemplary embodiment of the present invention.

Referring to FIG. 6, the grant management subheader newly proposed in the present invention is defined as three types. A grant management subheader 610 defined as type 1 (hereinafter referred to as “type 1 grant management subheader”) may be used in the multiple piggyback scheme and, particularly, is used to request bandwidth allocation for a generic MAC header CID. The type 1 grant management subheader 610 includes a “the number of PBR” field (n bits) 611 for recording the total number of CIDs needing bandwidth allocation and a PBR field (16-n bits) 613 for recording a bandwidth needed by a generic MAC header CID.

A grant management subheader 620 defined as type 2 (hereinafter referred to as “type 2 grant management subheader”) may be used in both the single piggyback scheme and the multiple piggyback scheme and, particularly, is used to request bandwidth allocation for CIDs other than a generic MAC header CID. The type 2 grant management subheader 620 includes a “the order of CID to PBR” field (n bits) 621 for indicating the order of a CID needing bandwidth allocation given in a CID list of an MS, and a PBR field (16-n bits) 623 for recording a bandwidth needed by the CID. Here, the CID list refers to a list in which all CIDs possessed by an MS are arranged in a particular order.

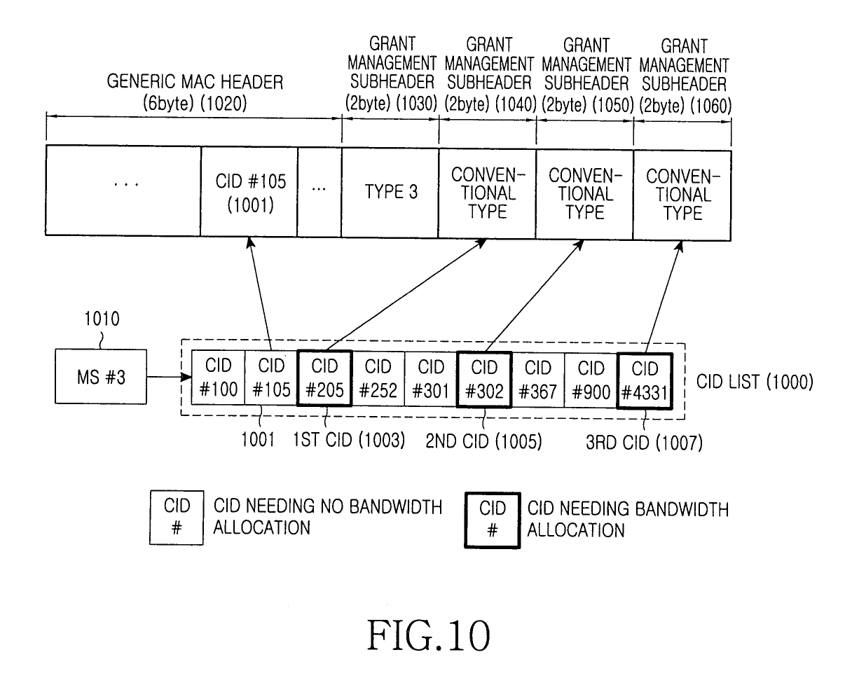

A grant management subheader 630 defined as type 3 (hereinafter referred to as “type 3 grant management subheader”) may be used in the multiple piggyback scheme. The type 3 grant management subheader 630 includes a CID MAP field (16 bits) 631 for recording a bitmap generated by setting a CID needing bandwidth allocation to “1” and setting a CID needing no bandwidth allocation to “0”, for each CID in a CID list. The type 3 grant management subheader 630 will be described in more detail below with reference to FIG. 10.

The size n of the “the number of PBR” field 611 or the “the order of CID to PBR” field 621 is determined by the following equation:

n=min(5,m). [Eqn. 1]

In Equation 1, m denotes the minimum integer satisfying 2^{m}≧k, and k denotes the total number of CIDs possessed by an MS corresponding to a generic MAC header CID. For example, supposing that the total number of CIDs possessed by an MS is 12, k=12, m=4, and n=4 are derived, and thus the size of the “the number of PBR” field or the “the order of CID to PBR” field is determined to be 4 bits.

Reference will now be made to a method of representing a bandwidth allocation request scheme by a combination of the type field LSB and the e-PBR bit of a generic MAC header, with reference to the following Table 3.

TABLE 3

| Type field | e-PBR | |
|---|---|---|
| LSB | bit | Bandwidth allocation request scheme |
| 0 | 0 | Perform no piggyback. |
| 1 | 0 | Perform single piggyback for generic MAC header |
| | | CID. |
| 1 | 1 | Perform single piggyback for CID other than |
| | | generic MAC header CID. |
| 0 | 1 | Perform multiple piggyback. |

Details of the bandwidth allocation request scheme according to combinations of the type field LSB and the e-PBR bit, shown in Table 3, are as follows:

(1) 00: indicates that no piggyback is performed.

(2) 10: indicates that bandwidth allocation is requested using single piggyback, and a target for the bandwidth allocation is a generic MAC header CID.

(3) 11: indicates that bandwidth allocation is requested using single piggyback, and a target for the bandwidth allocation is a CID other than a generic MAC header CID.

(4) 01: indicates that bandwidth allocation is requested using multiple piggyback.

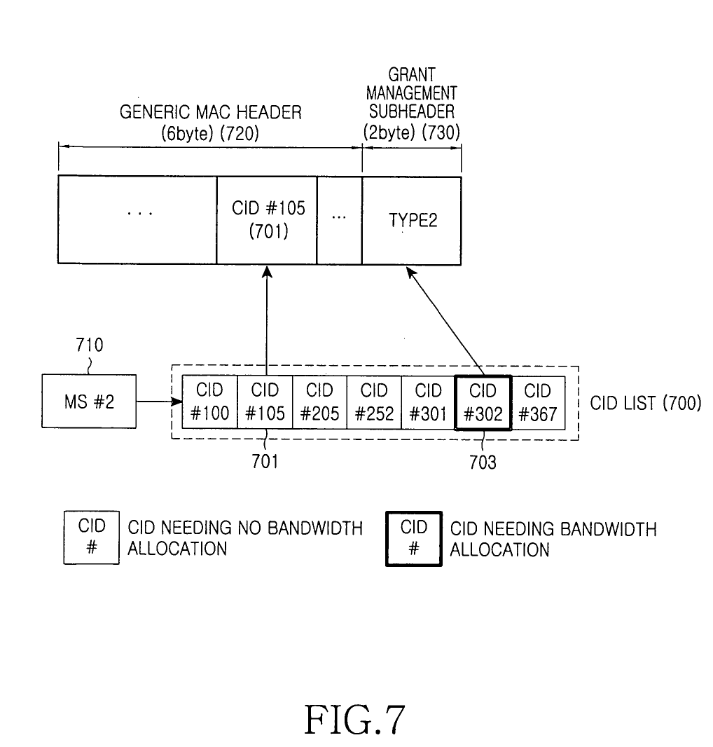

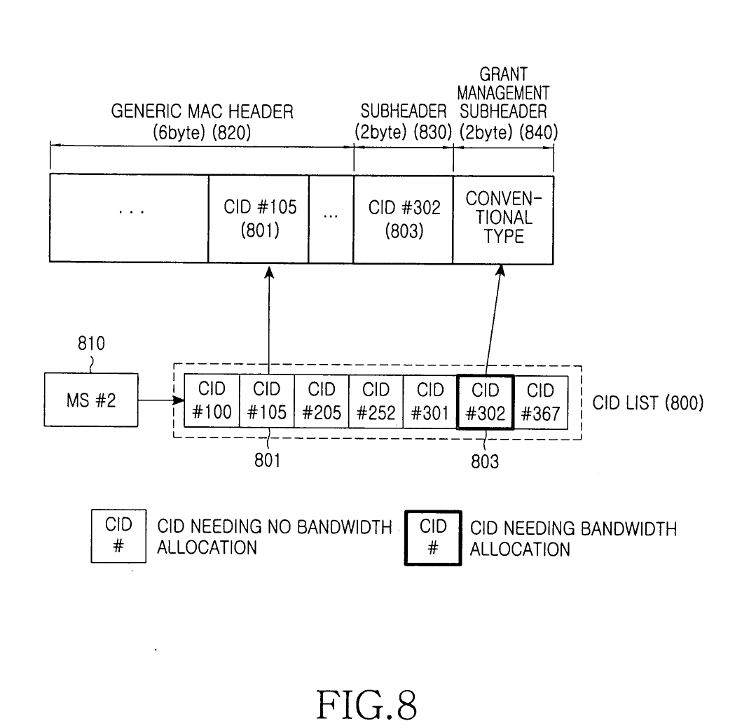

Next, a description will be given of an operation when both the type field LSB and the e-PBR bit are set to “1” (i.e., an operation of requesting bandwidth allocation by performing single piggyback for a CID other than a generic MAC header CID) in a communication system according to an exemplary embodiment of the present invention with reference to FIGS. 7 and 8.

FIG. 7 illustrates an operation of requesting bandwidth allocation by performing single piggyback for a CID other than a generic header CID in a communication system according to a first exemplary embodiment of the present invention.

Referring to FIG. 7, MS #2 710 transmits a message as illustrated in the drawing to a BS in order to request bandwidth allocation for a CID included in its CID list 700 (i.e., CID #302 703). Here, the generic MAC header CID of the MS #2 710 is CID #105 701, and the MS #2 710 uses a type 2 grant management subheader 730 newly proposed in the present invention to request bandwidth allocation for the CID #302 703.

That is, the MS #2 710 transmits a generic MAC header 720, with which a type 2 grant management subheader 730 containing the order of the CID #302 703 given in the CID list 700 and bandwidth information of the CID #302 703 is concatenated, to the BS. Here, the bandwidth information may be information on the amount of a bandwidth by way of example, and the information on the amount of a bandwidth may be information on a bandwidth amount itself or index information corresponding to the bandwidth amount. Also, the order of the CID #302 703, contained in the type 2 grant management subheader, is “6” because the CID #302 703 takes the sixth place in the CID list 700.

Upon receiving the message, the BS detects the MS #2 710 requesting bandwidth allocation through the generic MAC header 720, and detects the CID #302 703 taking the sixth place in the CID list 700 and a bandwidth needed by the CID #302 703 through the type 2 grant management subheader 730. The BS allocates the detected bandwidth to the MS #2 710.

FIG. 8 illustrates an operation of requesting bandwidth allocation by performing single piggyback for a CID other than a generic header CID in a communication system according to a second exemplary embodiment of the present invention.

Referring to FIG. 8, MS #2 810 transmits a message as illustrated in the drawing to a BS in order to request bandwidth allocation for a CID included in its CID list 800 (i.e., CID #302 803). Here, the generic MAC header CID of the MS #2 810 is CID #105 801, and the MS #2 810 uses a grant management subheader 840 as given in Table 1 (hereinafter referred to as “conventional type grant management subheader”) to request bandwidth allocation for the CID #302 803. With regard to this embodiment, the conventional type grant management subheader 840 contains only bandwidth information of the CID #302 803, and thus a 2 byte-subheader 830 containing the CID # 302 803 is transmitted along with the conventional grant management subheader 840.

That is, the MS #2 810 transmits a generic MAC header 820, with which a subheader 830 containing the CID #302 803 and a conventional type grant management subheader 840 containing bandwidth information of the CID #302 803 are concatenated, to the BS.

Upon receiving the message, the BS detects the MS #2 810 requesting bandwidth allocation through the generic MAC header 820, detects the CID #302 803 through the subheader 830, and detects a bandwidth needed by the CID #302 803 through the conventional type grant management subheader 840. The BS allocates the detected bandwidth to the MS #2 810.

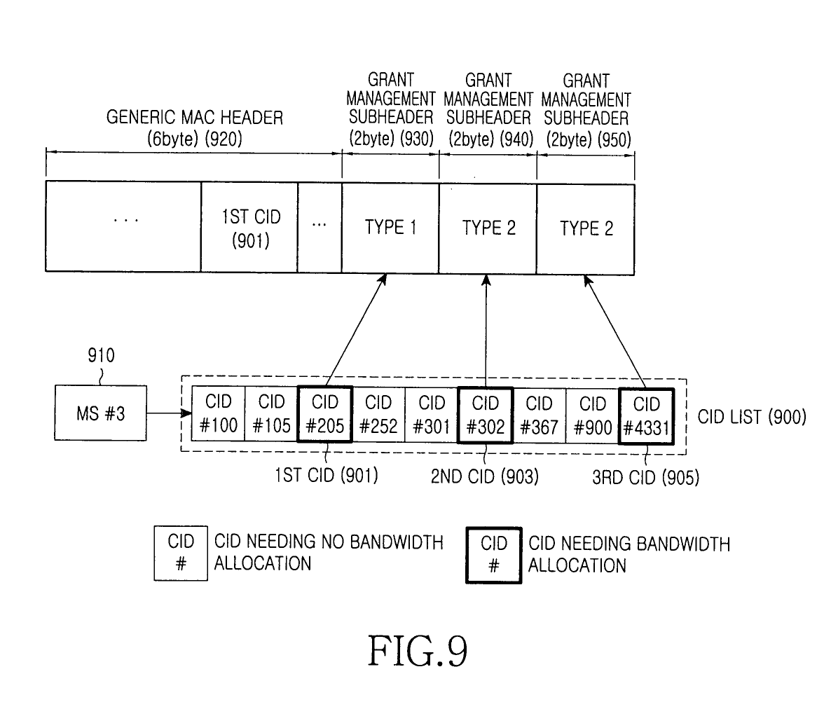

Next, a description will be given of an operation when the type field LSB is set to “0” and the e-PBR bit is set to “1” (i.e., an operation of requesting bandwidth allocation by performing multiple piggyback) in a communication system according to an exemplary embodiment of the present invention with reference to FIGS. 9 to 11.

FIG. 9 illustrates an operation of requesting bandwidth allocation by performing multiple piggyback in a communication system according to a third exemplary embodiment of the present invention.

Referring to FIG. 9, MS #3 910 transmits a message as illustrated in the drawing to a BS in order to request bandwidth allocation for a plurality of CIDs included in its CID list 900 (i.e., CID #205 (hereinafter referred to as “1^{st} CID”) 901, CID #302 (hereinafter referred to as “2^{nd} CID”) 903, and CID #4331 (hereinafter referred to as “3^{rd} CID”) 905). Here, the 1^{st} CID 901 is the generic MAC header CID of the MS #3 910, and thus the MS #3 910 uses a type 1 grant management subheader 930 newly proposed in the present invention to request bandwidth allocation for the 1^{st} CID 901. Also, the MS #3 910 uses type 2 grant management subheaders 940, 950 newly proposed in the present invention to request bandwidth allocation for the 2^{nd} and 3^{rd} CIDs 903, 905, respectively.

That is, the MS #3 910 transmits a generic MAC header 920, with which a type 1 grant management subheader 930 containing the total number of CIDs needing bandwidth allocation and bandwidth information of the 1^{st} CID 901, a type 2 grant management subheader 940 containing the order of the 2^{nd} CID 903 given in the CID list 900 and bandwidth information of the 2^{nd} CID 903, and a type 2 grant management subheader 950 containing the order of the 3^{rd} CID 905 given in the CID list 900 and bandwidth information of the 3^{rd} CID 905 are concatenated, to the BS. With regard to this embodiment, the total number of CIDs needing bandwidth allocation, contained in the type 1 grant management subheader 930, is “3” because a total of three CIDs need bandwidth allocation, the order of the 2^{nd} CID 903, contained in the type 2 grant management subheader 940 is “6” because the 2^{nd} CID 903 takes the sixth place in the CID list 900, and the order of the 3^{rd} CID 905, contained in the type 2 management subheader 950 is “9” because the 3^{rd} CID 905 takes the ninth place in the CID list 900.

Upon receiving the message, the BS detects the MS #3 910 requesting bandwidth allocation through the generic MAC header 920, detects the total number of CIDs needing bandwidth allocation and a bandwidth needed by the 1^{st} CID 901 through the type 1 grant management subheader 930, detects the 2^{nd} CID 903 taking the sixth place in the CID list 900 and a bandwidth needed by the 2^{nd} CID 903 through the type 2 grant management subheader 940, and detects the 3^{rd} CID 905 taking the ninth place in the CID list 900 and a bandwidth needed by the 3^{rd} CID 905 through the type 2 grant management subheader 950. The BS allocates the detected bandwidths to the MS #3 910.

In FIG. 9, an operation of requesting bandwidth allocation for a plurality of CIDs including a generic MAC header CID has been described by way of example, but it is obvious that the message as illustrated in the drawing may also be used in an operation of requesting bandwidth allocation by performing piggyback for a plurality of CIDs other than the generic MAC header CID.

FIG. 10 illustrates an operation of requesting bandwidth allocation by performing multiple piggyback in a communication system according to a fourth exemplary embodiment of the present invention.

Referring to FIG. 10, MS #3 1010 transmits a message as illustrated in the drawing to a BS in order to request bandwidth allocation for a plurality of CIDs included in its CID list 1000 (i.e., a 1st CID 1003, a 2^{nd} CID 1005, and a 3^{rd} CID 1007). Here, the generic MAC header CID of the MS #3 1010 is CID #105 1001, and the MS #3 1010 uses a type 3 grant management subheader 1030 newly proposed in the present invention and conventional type grant management subheaders 1040, 1050, 1060 to request bandwidth allocation for the 1^{st} , 2^{nd}, and 3^{rd} CIDs 1003, 1005, 1007, respectively.

That is, the MS #3 1010 transmits a generic MAC header 1020, with which a type 3 grant management subheader 1030 containing information on a bitmap generated by setting a CID needing bandwidth allocation to “1” and setting a CID needing no bandwidth allocation to “0”, for each CID included in the CID list 1000, a conventional type grant management subheader 1040 containing bandwidth information of the 1^{st} CID 1003, a conventional type grant management subheader 1050 containing bandwidth information of the 2^{nd} CID 1005, and a conventional type grant management subheader 1060 containing bandwidth information of the 3^{rd} CID 1007 are concatenated, to the BS. With regard to this embodiment, a bitmap generated corresponding to the CID list 1000 is “001001001” (9 bits), and the lower 7 bits of the bitmap is padded with “0”. Thus, the bitmap contained in the type 3 grant management subheader 1030 is “0010010010000000”.

Upon receiving the message, the BS detects the 1^{st}, 2^{nd}, and 3^{rd} CIDs 1003, 1005, 1007 needing bandwidth allocation through the type 3 grant management subheader 1030, and bandwidths needed by the respective detected CIDs through the conventional type grant management subheaders 1040, 1050, 1060. The BS allocates the detected bandwidths to the MS #3 1010.

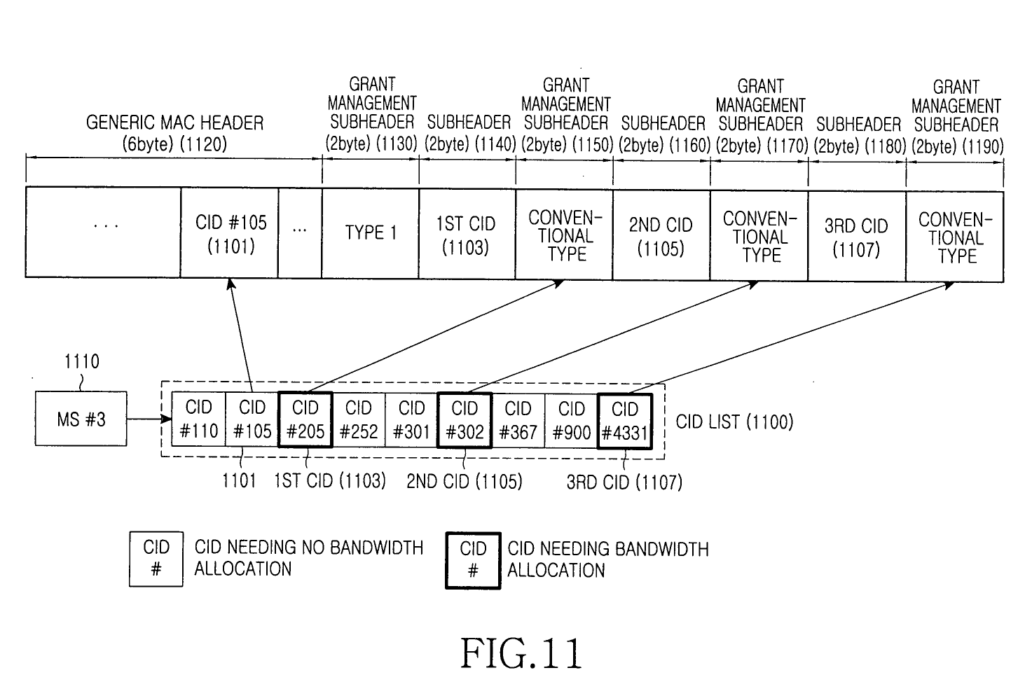

FIG. 11 illustrates an operation of requesting bandwidth allocation by performing multiple piggyback in a communication system according to a fifth exemplary embodiment of the present invention.

Referring to FIG. 11, MS #3 1110 transmits a message as illustrated in the drawing to a BS in order to request bandwidth allocation for a plurality of CIDs included in its CID list 1100 (i.e., a 1st CID 1103, a 2^{nd} CID 1105, and a 3^{rd} CID 1107). Here, the generic MAC header CID of the MS #3 1110 is CID #105 1101, and the MS #3 1110 uses a type 1 grant management subheader 1130 newly proposed in the present invention and conventional type grant management subheaders 1150, 1170, 1190 to request bandwidth allocation for the 1^{st}, 2^{nd}, and 3^{rd} CIDs 1103, 1105, 1107, respectively. With regard to this embodiment, the conventional type grant management subheaders 1150, 1170, 1190 contain only bandwidth information of the 1^{st}, 2^{nd}, and 3^{rd} CIDs 1103, 1105, 1107, respectively, and thus 2 byte-subheaders 1040, 1060, 1080 containing the CIDs 1103, 1105, 1107 corresponding to the respective information are transmitted along with the conventional grant management subheaders 1150, 1170, 1190.

That is, the MS #3 1110 transmits a generic MAC header 1120, with which a type 1 grant management subheader 1130 containing the total number of CIDs needing bandwidth allocation and bandwidth information of the CID #105 1101, a subheader 1140 containing the 1^{st} CID 1103, a conventional type grant management subheader 1150 containing bandwidth information of the 1^{st} CID 1103, a subheader 1160 containing the 2^{nd} CID 1105, a conventional type grant management subheader 1170 containing bandwidth information of the 2^{nd} CID 1105, a subheader 1180 containing the 3^{rd} CID 1107, and a conventional type grant management subheader 1190 containing bandwidth information of the 3^{rd} CID 1107 are concatenated, to the BS. With regard to this embodiment, the total number of CIDs needing bandwidth allocation, contained in the type 1 grant management subheader 1130, is “3” because a total of three CIDs need bandwidth allocation, and “0” is recorded in the field indicating the bandwidth information of the CID #105 1101 in the type 1 grant management subheader 1130 because the CID #105 1101 does not request bandwidth allocation.

Upon receiving the message, the BS detects the MS #3 1110 requesting bandwidth allocation through the generic MAC header 1120, detects the total number of CIDs needing bandwidth allocation through the type 1 grant management subheader 1130, detects the 1^{st} CID 1103 through the subheader 1140, detects a bandwidth needed by the 1^{st} CID 1103 through the conventional type grant management subheader 1150, detects the 2^{nd} CID 1105 through the subheader 1160, detects a bandwidth needed by the 2^{nd} CID 1105 through the conventional type grant management subheader 1170, detects the 3^{rd} CID 1107 through the subheader 1180, and detects a bandwidth needed by the 3^{rd} CID 1107 through the conventional type grant management subheader 1190. The BS allocates the detected bandwidths to the MS #3 1110.

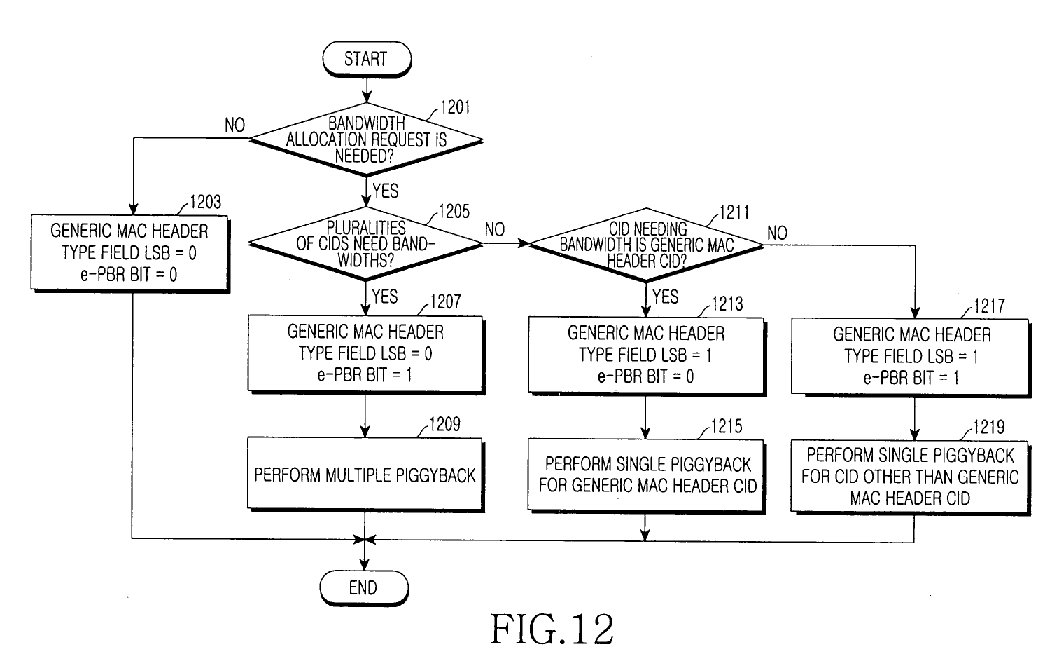

FIG. 12 illustrates a procedure of requesting bandwidth allocation by an MS in a communication system according to an exemplary embodiment of the present invention.

Referring to FIG. 12, in step 1201, the MS checks if it needs to request bandwidth allocation, and then proceeds to step 1205 when needing to request bandwidth allocation. If the MS does not need to request bandwidth allocation, it proceeds to step 1203 and sets both the type field LSB and the e-PBR bit of a generic MAC header to “0”.

In step 1205, the MS identifies a CID needing to be allocated a bandwidth, and checks if the identified CID is plural in number. If a plurality of CIDs is identified, the MS proceeds to step 1207, but if one CID is identified, proceeds to step 1211. In step 1207, the MS sets the type field LSB of the generic MAC header to “0”, sets the e-PBR bit of the generic MAC header to “1”, and then proceeds to step 1209. In step 1209, the MS requests its needed bandwidth allocation by performing multiple piggyback.

In step 1211, the MS checks if the CID needing a bandwidth is a generic MAC header CID. If a result of the check in step 1211 shows that the CID needing a bandwidth is a generic MAC header CID, the MS proceeds to step 1213. In step 1213, the MS sets the type field LSB of the generic MAC header to “1”, sets the e-PBR bit of the generic MAC header to “0”, and then proceeds to step 1215. In step 1215, the MS requests bandwidth allocation by performing single piggyback for the generic MAC header CID.

However, if a result of the check in step 1211 shows that the CID needing a bandwidth is not a generic MAC header CID, the MS proceeds to step 1217. In step 1217, the MS sets both the type field LSB and the e-PBR bit of the generic MAC header to “1” and then proceeds to step 1219. In step 1219, the ME requests bandwidth allocation by performing single piggyback for the CID other than the generic header CID.

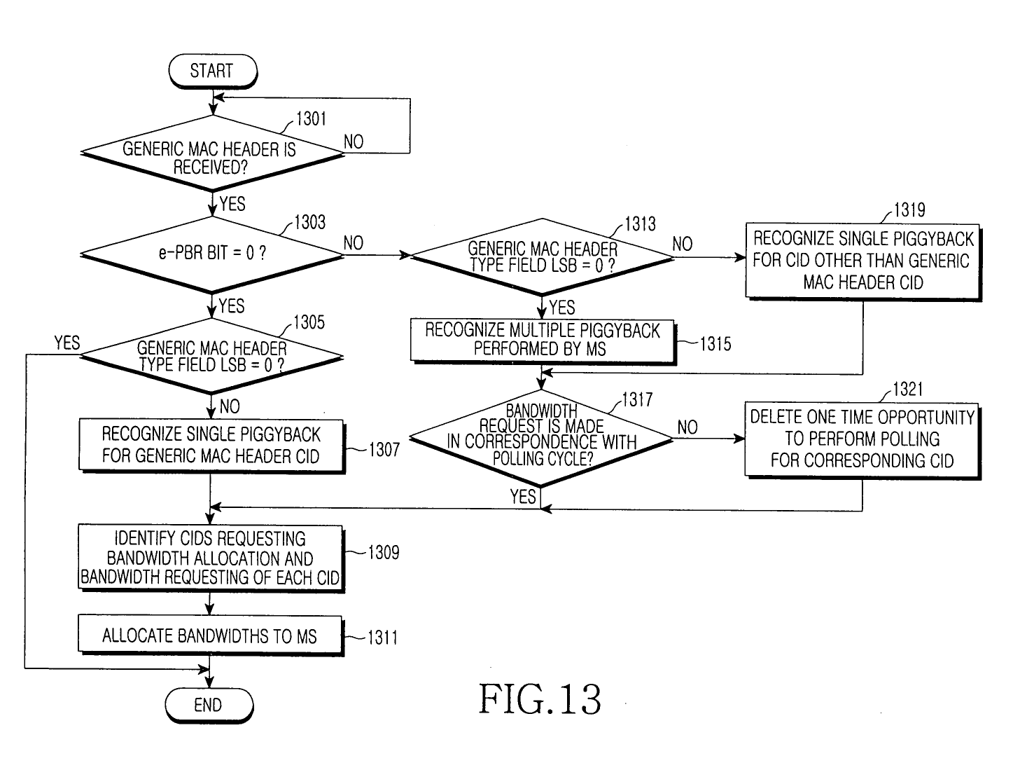

FIG. 13 illustrates a procedure of allocating a bandwidth by a BS in response to a bandwidth allocation request from an MS in a communication system according to an exemplary embodiment of the present invention.

Referring to FIG. 13, in step 1301, the BS checks if a generic header is received from the MS. If a generic MAC header is received, the BS proceeds to step 1303, and otherwise, proceeds to step 1301 again. In step 1303, the BS checks the e-PBR bit of the received generic MAC header. If the e-PBR bit is set to “0”, the BS proceeds to step 1305, and if the e-PBR bit is set to “1”, proceeds to step 1313.

In step 1305, the BS checks the type field LSB of the generic MAC header, and proceeds to step 1307 when the type field LSB of the generic header is set to “1”. That is, if the BS identifies through steps 1303 and 1305 that the type field LSB of the generic MAC header is set to “1” and the e-PBR bit of the generic MAC header is set to “0”, it proceeds to step 1307. In step 1307, the BS recognizes that the MS has requested bandwidth allocation by performing single piggyback for the generic MAC header CID included in the generic header, and then proceeds to step 1309. In step 1309, the BS identifies CIDs for which bandwidth allocation has been requested and bandwidth information of each CID and then proceeds to step 1311. In step 1311, the BS allocates bandwidths to the MS corresponding with the information identified in step 1309.

In addition, if a result of the check in step 1303 shows that the e-PBR bit is set to “1”, the BS proceeds to step 1313 and checks the type field LSB of the generic MAC header. If a result of the check in step 1313 shows that the type field LSB of the generic MAC header is set to “0”, the BS proceeds to step 1315. That is, if the BS identifies through steps 1303 and 1313 that the type field LSB of the generic header is set to “0” and the e-PBR bit of the generic MAC header is set to “1”, it proceeds to step 1315. In step 1315, the BS recognizes that the MS has requested bandwidth allocation by performing multiple piggyback, and then proceeds to step 1317. In step 1317, the BS checks if the bandwidth allocation request from the MS corresponds to the polling cycle of the relevant CID. If the bandwidth allocation request corresponds to the polling cycle, the BS proceeds to step 1309 and, otherwise, proceeds to step 1321. In step 1321, the BS deletes a one time opportunity to perform polling for the relevant CID in the first place, and then proceeds to step 1309. In this case, the BS may allocate a resource for the polling to another use.

Contrarily, if a result of the check in step 1313 shows that the type field LSB is set to “1”, the BS proceeds to step 1319. That is, if the BS identifies through steps 1303 and 1313 that both the type field LSB and the e-PBR bit of the generic header are set to “1”, it proceeds to step 1319. In step 1319, the BS recognizes that the MS has requested bandwidth allocation by performing single piggyback for a CID other than the generic MAC header CID, and then proceeds to step 1317.

In the foregoing, the scheme to request bandwidth allocation by using single piggyback or multiple piggyback according to combinations of the type field LSB 506 and the e-PBR 513 bit of a generic MAC header has been described.

In the following embodiments of the present invention, a new type of extended subheader will be defined, and then a scheme to request bandwidth allocation by using single piggyback or multiple piggyback will be described. In order to use the extended subheader as defined below, the ESF 507 bit of a generic MAC header is set to “1”. The ESF 507 bit is a bit indicating whether or not the extended subheader exists, and an MS transmits a generic MAC header with an extended subheader concatenated therewith to a BS when the ESF 507 bit of the generic MAC header is set to “1”.

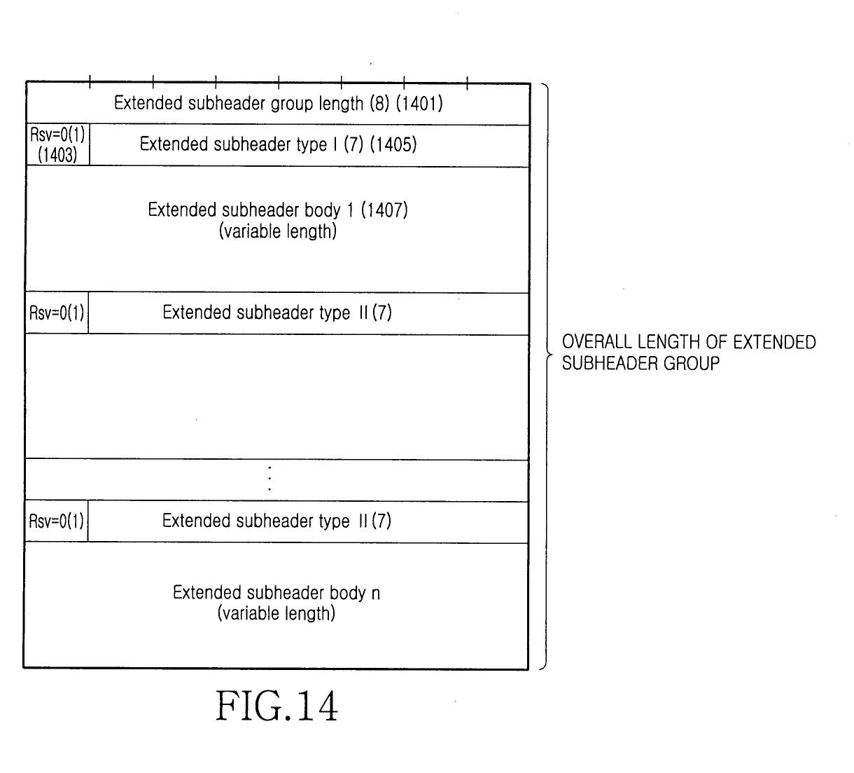

FIG. 14 illustrates a structure of an extended subheader group.

Referring to FIG. 14, the extended subheader includes an extended subheader group LEN field 1401 indicating the overall length of the extended subheader, a reserved field 1403, an extended subheader type 1 field 1405, an extended subheader body 1 field 1407, and so forth. Here, the extended subheader may be defined as up to 128 types according to the value of the extended subheader type field, and the extended subheader body field corresponding thereto is also newly defined whenever a new extended subheader type is defined.

That is, when a generic header with the extended subheader concatenated therewith is transmitted, the overall length of the extended subheader group is first indicated, and then needed extended subheader types are sequentially concatenated thereto by making reference to the following Tables 4 and 5. Also, the extended subheader may be divided according to the value of the extended subheader type field in uplink and downlink respectively. First, extended subheader types divided according to the value of the extended subheader type field in uplink are given below in Table 4.

TABLE 4

| | | Extended |
|---|---|---|
| Extended | | subheader body |
| subheader Type | Name | size (byte) |
| 0 | SDU_SN extended subheader | 1 |
| 1 | DL sleep control extended subheader | 3 |
| 2 | Feedback request extended subheader | 3 |
| 3 | SN request extended subheader | 1 |
| 4 | PDU SN (short) extended subheader | 1 |
| 5 | PDU SN (long) extended subheader | 2 |
| 6-127 | Reserved | — |

Next, extended subheader types divided according to the value of the extended subheader type field in downlink are given below in Table 5.

TABLE 5

| Extended | | Extended |
|---|---|---|
| subheader | | subheader body |
| type | Name | size (byte) |
| 0 | MIMO mode feedback extended subheader | 1 |
| 1 | UL Tx power report extended subheader | 1 |
| 2 | Mini-feedback extended subheader | 2 |
| 3 | PDU SN (short) extended subheader | 1 |
| 4 | PDU SN (long) extended subheader | 2 |
| 5-127 | Reserved | — |

Accordingly, the present invention proposes a way to request bandwidth allocation in the single piggyback scheme or the multiple piggyback scheme by using the reserved regions available when the extended subheader type field has a value of 6 to 127 in uplink, and has a value of 5 to 127 in downlink.

In the following embodiments of the present invention, it will be assumed that an MS requests bandwidth allocation by performing single piggyback when the extended subheader type field has a value of A, and requests bandwidth allocation by using a type 2 grant management subheader to perform multiple piggyback when the extended subheader type field has a value of B, and requests bandwidth allocation by using a type 3 grant management subheader to perform multiple piggyback when the extended subheader type field has a value of C. Also, although the value of the extended subheader type field is defined as A, B, or C, it is obvious that any of values corresponding to the reserved regions in Tables 4 and 5 (i.e., any of values of 6 to 127 in uplink and 5 to 127 in downlink) may be used as the value of the extended subheader type field.

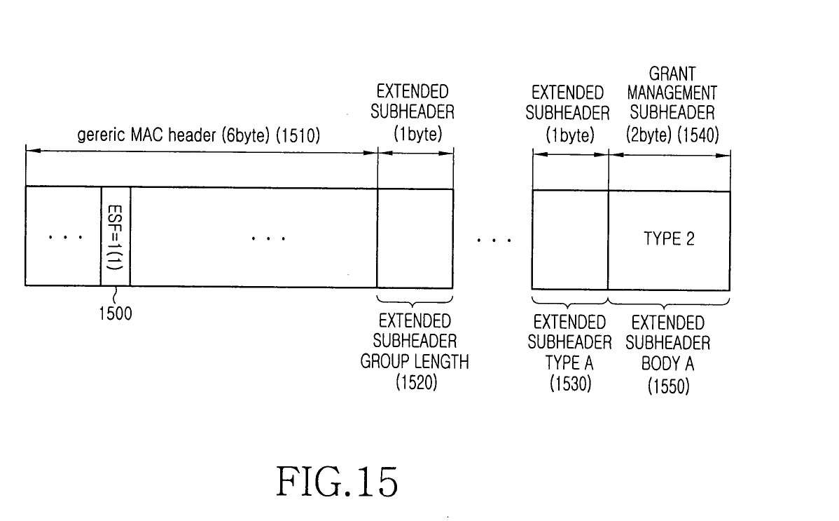

FIG. 15 illustrates an operation of requesting bandwidth allocation by performing single piggyback in a communication system according to a sixth exemplary embodiment of the present invention.

Referring to FIG. 15, an MS transmits a message as illustrated in the drawing to a BS in order to request bandwidth allocation for a CID included in its CID list. Here, the MS sets the ESF 1500 of a generic header 1510 to “1”, and transmits the generic MAC header 1510, with which an extended subheader group LEN field 1520, a corresponding extended subheader, extended subheader type A 1530, and extended subheader body A 1550 corresponding to the extended subheader type A 1530 are concatenated, so as to request bandwidth allocation by using the single piggyback scheme. With regard to this embodiment, the extended subheader body A 1550 contains a type 2 grant management subheader 1540 newly proposed in the present invention.

That is, the MS transmits the generic MAC header 1510, with which the type 2 grant management subheader 1540 containing the order of the CID requesting bandwidth allocation in the CID list, and bandwidth information of the CID requesting bandwidth allocation is concatenated, to the BS. Here, the bandwidth information may be information on the amount of a bandwidth by way of example, and the information on the amount of a bandwidth may be information on a bandwidth amount itself or index information corresponding to the bandwidth amount. The MS may also replace the “the order of CID to PBR” field of the type 2 grant management subheader 1540 by a private CID index. The private CID index indicates a CID number in CIDs possessed by the MS.

Upon receiving the message, the BS detects the order of the CID for which to perform bandwidth allocation, given in the CID list, and a bandwidth requested by the CID for which to perform bandwidth allocation through the type 2 grant subheader 1540 to thereby allocate the detected bandwidth to the MS.

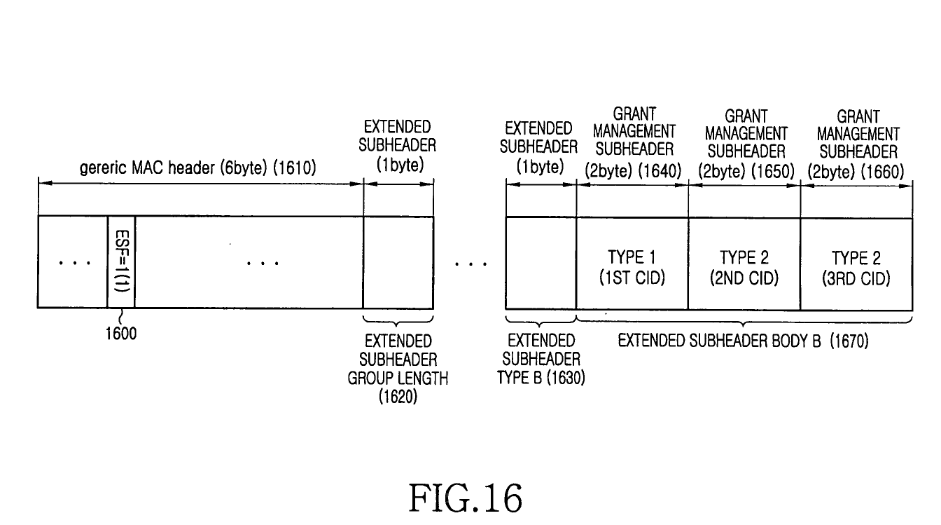

FIG. 16 illustrates an operation of requesting bandwidth allocation by performing multiple piggyback in a communication system according to a seventh exemplary embodiment of the present invention.

Referring to FIG. 16, an MS transmits a message as illustrated in the drawing to a BS in order to request bandwidth allocation for a plurality of CIDs included in its CID list. In the following description, it will be assumed that the plurality of CIDs consist of a 1^{st} CID, a 2^{nd} CID, and a 3^{rd} CID. The MS sets the ESF 1600 of a generic header 1610 to “1”, and transmits the generic MAC header 1610, with which an extended subheader group LEN field 1620, a corresponding extended subheader, extended subheader type B 1630, and extended subheader body B 1670 corresponding to the extended subheader type B 1630 are concatenated, so as to request bandwidth allocation by using the multiple piggyback scheme. With regard to this embodiment, the extended subheader body B 1670 contains a type 1 grant management subheader 1640 and type 2 grant management subheaders 1650, 1660 newly proposed in the present invention.

That is, the MS transmits the generic MAC header 1610, with which the type 1 grant management subheader 1640 containing the total number of CIDs for which to request bandwidth allocation and bandwidth information of the CID included in the generic MAC header 1610 (i.e., the 1^{st} CID, the type 2 grant management subheader 1650 containing the order of the 2^{nd} CID given in the CID list and bandwidth information of the 2^{nd} CID, and the type 2 grant management subheader 1660 containing the order of the 3^{rd} CID given the CID list and bandwidth information of the 3^{rd} CID are concatenated) to the BS.

Since the length of the extended subheader body B 1670 varies according to the total number of CIDs for which to request bandwidth allocation, and the length of the respective subheaders for requesting bandwidths of the CIDs for which to request bandwidth allocation is 2 bytes, the length of the extended subheader body B 1670 corresponds to the total number of the CIDs for which to request bandwidth allocation×the length of the subheaders for requesting bandwidths=3×2 bytes. In other words, the length of the extended subheader body B 1670 is two times the value recorded in the “the number of PBR” field of the type 1 grant management subheader 1640. The MS may also replace the “the order of CID to PBR” fields of the type 2 grant management subheaders 1650, 1660 by a private CID index.

Upon receiving the message, the BS detects the total number of CIDs for which to perform bandwidth allocation and a bandwidth requested by the 1^{st} CID through the type 1 grant subheader 1640, detects the order of the 2^{nd} CID given in the CID list and a bandwidth requested by the 2^{nd} CID through the type 2 grant management subheader 1650, and detects the order of the 3^{rd} CID given in the CID list and a bandwidth requested by the 3^{rd} CID through the type 2 grant management subheader 1660 to thereby allocate the detected bandwidths to the MS.

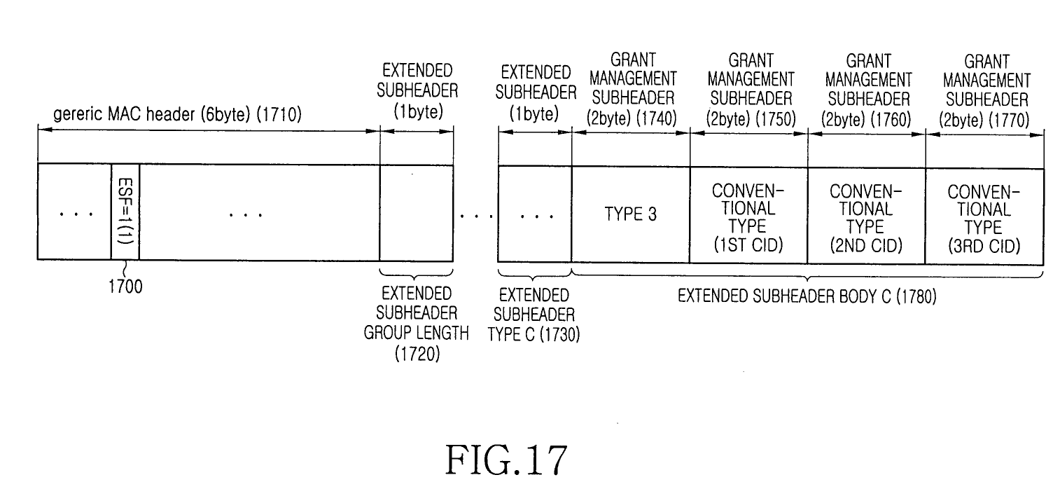

FIG. 17 illustrates an operation of requesting bandwidth allocation by performing multiple piggyback in a communication system according to an eighth exemplary embodiment of the present invention.

Referring to FIG. 17, an MS transmits a message as illustrated in the drawing to a BS in order to request bandwidth allocation for a 1^{st} CID, a 2^{nd} CID, and 3^{rd} CID included in its CID list. The MS sets the ESF 1700 of a generic header 1710 to “1”, and transmits the generic MAC header 1710, with which an extended subheader group LEN field 1720, a corresponding extended subheader, extended subheader type C 1730, and extended subheader body C 1780 corresponding to the extended subheader type 1730 are concatenated, so as to request bandwidth allocation by using the multiple piggyback scheme. With regard to this embodiment, the extended subheader body C 1780 contains a type 3 grant management subheader 1740 newly proposed in the present invention and conventional type grant management subheaders 1750, 1760, 1770.

That is, the MS transmits the generic MAC header 1710, with which the type 3 grant management subheader 1740 containing bitmap information generated by setting a CID for which to request bandwidth allocation to “1” and setting a CID for which not to request bandwidth allocation to “0”, for each CID included in the CID list of the MS, the conventional type grant management subheader 1750 containing bandwidth information of the 1^{st} CID, the conventional type grant management subheader 1760 containing bandwidth information of the 2^{nd} CID, and the conventional type grant management subheader 1770 containing bandwidth information of the 3^{rd} CID are concatenated, to the BS. Thus, the length of the extended subheader body C 1780 is two times the total number of the CIDs for which to request bandwidth allocation (i.e., the number of bits set to “1” in the type 3 grant management subheader 1740+the length of the type 3 grant management subheader (2bytes)=3×2+2 bytes).

Upon receiving the message, the BS detects CIDs for which to perform bandwidth allocation (i.e., the 1^{st}, 2^{nd}, and 3^{rd} CIDS) through the type 3 grant subheader 1740, and detects bandwidths needed by the detected CIDS through the conventional type grant management subheaders 1750, 1760, 1770, respectively, to thereby allocate the bandwidths requested by the respective CIDs to the MS.

As described above, the present invention enables an MS to request bandwidth allocation by using the piggyback scheme, even for CIDs other than a generic MAC header CID, thereby reducing overhead due to the bandwidth allocation request. Also, in the present invention, since although an MS requests bandwidth allocation for each of a plurality of CIDs by using the piggyback scheme, a BS can know a bandwidth needed by each CID without overhead, and the quality of service (QoS) of each CID can be improved.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of requesting bandwidth allocation by a mobile station having at least two connection identifiers in a communication system, the method comprising the steps of:
detecting at least one connection identifier needing a bandwidth allocation;
when the detected at least one connection identifier is one in number, generating a grant management subheader including a region for recording an order of the connection identifier in a list where the connection identifiers of the mobile station are arranged in a particular order, and a region for recording an information on a bandwidth requested for the connection identifier; and
transmitting a generic MAC (media access control) header with the grant management subheader concatenated thereto to a base station,
wherein the connection identifier is different from a connection identifier included in the generic MAC header.

2. The method as claimed in claim 1, wherein the generic MAC header contains a first and second bits indicating that the connection identifier needing the bandwidth allocation is one in number and is different from the connection identifier included in the generic MAC header.

3. The method as claimed in claim 1, wherein a size of the region for recording the order of the connection identifier is determined by a following equation,
n=min(5,m)
where, m denotes a minimum integer satisfying 2^{m}≧k, and k denotes a total number of connection identifiers possessed by the mobile station.

4. A method of requesting bandwidth allocation by a mobile station having at least two connection identifiers in a communication system, the method comprising the steps of:
detecting at least one connection identifier needing a bandwidth allocation;
when the detected at least one connection identifier is one in number, generating a subheader for recording the connection identifier needing the bandwidth allocation, and a grant management subheader for recording an information on a bandwidth requested for the connection identifier; and
transmitting a generic MAC (media access control) header with the subheader and the grant management subheader concatenated thereto to a base station,
wherein the connection identifier is different from a connection identifier included in the generic MAC header.

5. The method as claimed in claim 4, wherein the generic MAC header contains a first and second bits indicating that the connection identifier needing the bandwidth allocation is one in number and is different from the connection identifier included in the generic MAC header.

6. A method of requesting bandwidth allocation by a mobile station having at least two connection identifiers in a communication system, the method comprising the steps of:
detecting at least one connection identifier needing a bandwidth allocation;
when the detected at least one connection identifier is plural in number, generating a grant management subheader including a region for recording a total number of the connection identifiers needing a bandwidth allocation and a region for recording an information on a bandwidth requested for a connection identifier included in a generic MAC (media access control) header, and a grant management subheader including, for each of the connection identifiers needing the bandwidth allocation except a connection identifier included in the generic MAC header, a region for recording an order of a corresponding connection identifier, given in a list where the connection identifiers of the mobile station are arranged in a particular order, and a region for recording an information on a bandwidth requested for the corresponding connection identifier; and
transmitting the generic MAC header with the grant management subheaders concatenated thereto to a base station.

7. The method as claimed in claim 6, wherein the generic MAC header contains a first and second bits indicating that the connection identifier needing the bandwidth allocation is plural in number.

8. The method as claimed in claim 6, wherein each size of the region for recording the total number of the connection identifiers and the region for recording the order of the corresponding connection identifier is determined by a following equation,
n=min(5,m)
where, m denotes a minimum integer satisfying 2^{m}≧k, and k denotes a total number of CIDs possessed by the mobile station.

9. A method of requesting bandwidth allocation by a mobile station having at least two connection identifiers in a communication system, the method comprising the steps of:
detecting at least one connection identifier needing a bandwidth allocation;
when the detected at least one connection identifier is plural in number, generating a grant management subheader for recording a bitmap used to distinguish between the connection identifiers needing the bandwidth allocation and the connection identifiers needing no bandwidth allocation in a list where the connection identifiers of the MS are arranged in a particular order, and a grant management subheader for recording an information on a bandwidth requested for each of the connection identifiers needing the bandwidth allocation except a connection identifier included in the generic MAC header; and
transmitting the generic MAC header with the grant management subheaders concatenated thereto to a base station.

10. The method as claimed in claim 9, wherein the generic MAC header contains a first and second bits indicating that the connection identifier needing the bandwidth allocation is plural in number.

11. A method of requesting bandwidth allocation by a mobile station having at least two connection identifiers in a communication system, the method comprising the steps of:
detecting at least one connection identifier needing a bandwidth allocation;
when the detected at least one connection identifier is plural in number, generating a grant management subheader including a region for recording a total number of the connection identifiers needing the bandwidth allocation and a region for recording information on a bandwidth requested for a connection identifier included in a generic MAC (media access control) header, a subheader for recording each of the connection identifiers needing the bandwidth allocation, and a grant management subheader for recording an information on a bandwidth requested for each of the connection identifiers needing the bandwidth allocation; and
transmitting the generic MAC header with the subheader and the grant management subheaders concatenated thereto to a base station.

12. The method as claimed in claim 11, wherein the generic MAC header contains a first and second bits indicating that the connection identifier needing the bandwidth allocation is plural in number.

13. The method as claimed in claim 11, wherein the size of the region for recording the total number of the connection identifiers is determined by a following equation,
n=min(5,m)
where, m denotes a minimum integer satisfying 2^{m}≧k, and k denotes a total number of CIDs possessed by the mobile station.

14. A method of requesting bandwidth allocation by a mobile station having at least two connection identifiers in a communication system, the method comprising the steps of:
detecting at least one connection identifier needing a bandwidth allocation; and
when the detected at least one connection identifier is one in number, transmitting a generic MAC (media access control) header, to which an extended subheader group length field, an extended subheader type field having a first value, and an extended subheader body field corresponding to the extended subheader type field are concatenated, to a base station,
wherein the extended subheader body field comprises a grant management subheader including a region for recording an order of the connection identifier given in a list where the connection identifiers of the mobile station are arranged in a particular order and a region for recording an information on a bandwidth requested for the connection identifier.

15. The method as claimed in claim 14, wherein an extended subheader type is identified by a value of the extended subheader type field, and the first value of the extended subheader type field is preset to at least one of values corresponding to a reserved region among extended subheader type field values.

16. A method of requesting bandwidth allocation by mobile station having at least two connection identifiers in a communication system, the method comprising the steps of:
detecting at least one connection identifier needing a bandwidth allocation; and
when the detected at least one connection identifier is plural in number, transmitting a generic MAC (media access control) header to which an extended subheader group length field, an extended subheader type field having a second value, and an extended subheader body field corresponding to the extended subheader type field are concatenated, to a base station,
wherein the extended subheader body field comprises a grant management subheader including a region for recording a total number of the connection identifiers needing the bandwidth allocation and a region for recording an information on a bandwidth requested for a connection identifier included in the generic MAC header, and a grant management subheader including, for each of the connection identifiers needing the bandwidth allocation except a connection identifier included in the generic MAC header, a region for recording an order of a corresponding connection identifier, given in a list where the connection identifiers of the mobile station are arranged in a particular order, and a region for recording an information on a bandwidth requested for the corresponding connection identifier.

17. The method as claimed in claim 16, wherein an extended subheader type is identified by a value of the extended subheader type field, and the second value of the extended subheader type field is preset to at least one of values corresponding to a reserved region among extended subheader type field values.

18. A method of requesting bandwidth allocation by a mobile station having at least two connection identifiers in a communication system, the method comprising the steps of:
detecting at least one connection identifier needing a bandwidth allocation; and
when the detected at least one connection identifier is plural in number, transmitting a generic MAC (media access control) header to which an extended subheader group length field, an extended subheader type field having a third value, and an extended subheader body field corresponding to the extended subheader type field are concatenated, to a base station,
wherein the extended subheader body field comprises a grant management subheader for recording a bitmap used to distinguish between the connection identifiers needing the bandwidth allocation and connection identifiers needing no bandwidth allocation in a list where the connection identifiers of the mobile station are arranged in a particular order, and a grant management subheader for recording an information on a bandwidth requested for each of the connection identifiers needing the bandwidth allocation except a connection identifier included in the generic MAC header.

19. The method as claimed in claim 18, wherein an extended subheader type is identified by a value of the extended subheader type field, and the third value of the extended subheader type field is preset to at least one of values corresponding to a reserved region among extended subheader type field values.
